(19) United States
(12) Patent Application Publication
(10) Pub. No.: US 2026/0067248 A1
(43) Pub. Date: Mar. 5, 2026

(54) ROTATING A MEDIA ACCESS CONTROL (MAC) ADDRESS OF AN ACCESS POINT (AP)

(71) Applicant: Cisco Technology, Inc., San Jose, CA (US)

(72) Inventors: Robert E. BARTON, Richmond (CA); Jerome HENRY, Pittsboro, NC (US); Malcolm M. SMITH, Richardson, TX (US)

(21) Appl. No.: 19/281,610

(22) Filed: Jul. 26, 2025

Related U.S. Application Data
(60) Provisional application No. 63/690,998, filed on Sep. 5, 2024.

(51) Int. Cl. H04L 61/50

(52) U.S. Cl. CPC H04L 61/50

(57) ABSTRACT

An AP may include two MAC addresses: a public MAC address and a private MAC address. A STA may use the public MAC address to associate with the AP. When the STA is associated with the AP, the AP may inform the STA of the private MAC address for communication. The AP may rotate the private MAC address while the STA remains associated with the AP through the public MAC address.

### CROSS-REFERENCE TO RELATED APPLICATIONS

This application claims benefit of co-pending U.S. provisional patent application Ser. No. 63/690,998 filed Sep. 5, 2024. The aforementioned related patent application is herein incorporated by reference in its entirety.

### TECHNICAL FIELD

Embodiments presented in this disclosure generally relate to rotating a media access control (MAC) address of an access point (AP). More specifically, embodiments disclosed herein relate to rotating a MAC address of an AP while maintaining associations with stations (STAs).

### BACKGROUND

A malicious device or user may attempt to track a MAC address of a STA to mimic the STA. Similarly, the malicious device or user may attempt to track a public MAC address of an AP. The AP broadcasts the public MAC address to STAs for the STAs to associate with the AP and to communicate with the AP. If the malicious device or user mimics the AP using the public MAC address, the malicious device or user could access a STA that attempts to associate or communicate with the AP. To prevent the malicious device or user from tracking the STA, the STA may periodically rotate or randomize a MAC address of the STA. The AP, however, may not rotate the public MAC address of the AP without causing the STA to disassociate or disconnect from the AP.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an AP rotating one of two MAC addresses while maintaining association with a STA, according to one embodiment.

FIG. 2 depicts a flowchart of an AP rotating one of two MAC addresses while maintaining association with a STA, according to one embodiment.

FIG. 3 depicts a flowchart of an AP transmitting a trigger frame before rotating one of two MAC addresses while maintaining association with a STA, according to one embodiment.

FIG. 4 depicts a block diagram of an AP transmitting multiple trigger frames before rotating one of two MAC addresses while maintaining association with multiple STAs, according to one embodiment.

FIG. 5 depicts a flowchart of an AP transmitting a vector of MAC addresses before rotating one of two MAC addresses while maintaining association with a STA, according to one embodiment.

FIG. 6 depicts an example network device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is an AP that includes one or more memories and one or more processors communicatively coupled to the one or more memories, wherein the one or more processors are configured to, individually or collectively, perform an operation. The operation includes transmitting a public MAC address to a STA for communicating with the AP as the STA associates with the AP. The operation further includes in response to the STA associating with the AP, transmitting a private MAC address to the STA, such that the STA communicates with the AP using the private MAC address instead of the public MAC address. The operation further includes rotating the private MAC address to a new private MAC address, which remains associated with the AP while the private MAC address is rotated to the new private MAC address. In one embodiment, the disclosure includes a method and a non-transitory computer-readable medium.

### Example Embodiments

The present disclosure describes an access point (AP) that rotates a private media access control (MAC) address of the AP without necessarily causing a station (STA) to dissociate or disconnect from the AP. In some instances, a STA transmits a probe request. The AP may transmit a response to the probe request with a public MAC address of the AP to begin associating with the STA. In certain instances, the AP broadcasts a beacon with a public MAC address of the AP. The STA may receive the beacon and begin associating with the AP using the public MAC address in the beacon. As the STA and the AP are associating, the STA and the AP may authenticate each other by passing authentication messages to each other.

When the STA and the AP finish association, the AP may transmit a private MAC address of the AP to the STA. The private MAC address may be an alternative address that the STA and the AP use to communicate. Because the AP uses the private MAC address to communicate with the STA, the AP knows that the STA is authenticated and associated with the AP. The AP may rotate the private MAC address after a period of time to reduce the chances that a malicious device or user become aware of the private MAC address. Rotating the private MAC address, however, may cause the STA to disassociate or disconnect from the AP. To prevent the STA from dissociating from the AP when the AP rotates the private MAC address, according to one embodiment, the AP may broadcast the next private MAC address before the current private MAC address expires. The AP may also broadcast a timer that indicates a remaining amount of time before the AP rotates to the next private MAC address.

In some instances, before the AP rotates the private MAC address, the AP transmits a trigger frame to the STA, indicating the next private MAC address that the AP will use. When the STA receives the trigger frame, the STA may transmit an acknowledgement to the AP. When the AP receives the acknowledgement from the STA, the AP transmits another trigger frame to the STA indicating that the STA should communicate with the AP using the next private MAC address.

In certain instances, before the AP rotates the private MAC address, the AP transmits a trigger frame to the STA indicating that the AP will rotate to the next private MAC address along with a list of new MAC addresses that the AP may use. The AP may include in the trigger frame an algorithm for determining which of the new MAC addresses the AP will use as the next private MAC address. In some instances, the AP transmits the algorithm to the STA when the AP transmits the private MAC address to the STA.

In some embodiments, the described system provides several technical advantages. For example, the AP may rotate the private MAC address, which protects the AP from malicious devices and users mimicking the AP, while maintaining an association with the STA. When the AP transmits an algorithm to the STA, the AP may improve the security of the rotation of the private MAC address.

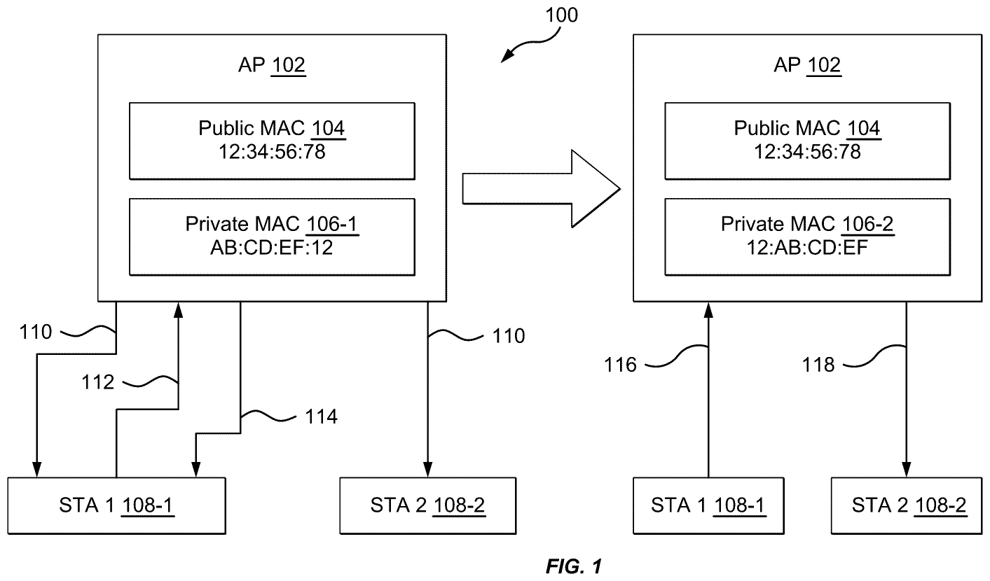

FIG. 1 depicts a system 100 of an AP 102 rotating a private MAC address 106-1 while maintaining association with STA 108-1. The AP 102 includes two different MAC addresses, a public MAC address 104 and the private MAC address 106-1. The AP 102 may transmit a broadcast signal 110 with the public MAC address 104 such that a STA can use the public MAC address 104 to associate with the AP 102. In one embodiment, the STA 108-1 and a STA 108-2 receive the broadcast signal 110. The STAs 108-1 and 108-2 may choose to associate with the AP 102. For example, the STA 108-1 transmits a response signal 112 to the AP 102 so that the STA 108-1 may attempt to associate with the AP 102. The STA 108-1 and AP 102 may continue the association process by going through a simultaneous authentication of equals (SAE) process to authenticate the STA 108-1. The STA 108-1 and the AP 102 may follow-up the SAE process with a 4-way handshake to generate a pairwise transient key (PTK) and a group temporal key (GTK) for secure communication between the STA 108-1 and the AP 102.

In one embodiment, after the 4-way handshake, the AP 102 may transmit a private signal 114 to the STA 108-1 that includes the private MAC address 106-1. The private signal 114 may be an encoded signal to help prevent a malicious device or user from accessing the private signal 114. The private signal 114 may indicate that the STA 108-1 should use the private MAC address 106-1 to communicate with the AP 102. In one embodiment, the STA 108-1 may be able to communicate with the AP 102 through the private MAC address 106-1 and the public MAC address 104. The AP 102 can differentiate associated STAs and unassociated STAs based on whether the STAs use the public MAC address 104 or the private MAC address 106-1. For example, by the STA 108-1 communicating with the AP 102 through the private MAC address 106-1, the AP 102 knows that the STA 108-1 is associated with the AP 102. Additionally, if the STA 108-2 transmits a signal to the AP 102, the AP 102 knows that the STA 108-2 is not associated with the AP 102.

The AP 102 may determine that the private MAC address 106-1 should be rotated to help prevent a malicious device or user from using the private MAC address 106-1. The AP 102 may transmit a frame to the STA 108-1 indicating a new private MAC address 106-2 along with a time when the AP 102 will start using the new private MAC address 106-2. In one embodiment, the frame indicating the new private MAC address 106-2 is transmitted in the private signal 114. The AP 102 may transmit the frame indicating the new private MAC address 106-2 to each STA that is associated with the AP 102. The time when the AP 102 will start using the new private MAC address 106-2 may be a timestamp or an amount of time from a current timestamp. When the time indicated in the frame occurs, the AP 102 rotates the private MAC address 106-1 to the new private MAC address 106-2. Notably, when the AP 102 rotates the private MAC address 106-1, the STA 108-1 would remain associated with the AP 102 through the public MAC address 104. In one embodiment, the AP 102 may accept signals sent using the private MAC address 106-1 for a period of time after rotating to the new private MAC address 106-2. Because the STA 108-1 remained associated with the AP 102, the STA 108-1 may continue communicating with the AP 102 after the AP 102 rotates to the new private MAC address 106-2. For example, the STA 108-1 may transmit a data signal 116 to the AP 102 using the new private MAC address 106-2. The AP 102 may transmit another beacon signal 118 to STAs (such as the STA 108-2) for the STAs to associate with the AP 102.

In one embodiment, the AP 102 may transmit a first trigger frame to the STA 108-1 indicating that the AP 102 will rotate the private MAC address 106-1 along with the new private MAC address 106-2. The AP 102 may transmit the first trigger frame to each STA associated to the AP 102. In one embodiment, the first trigger frame is transmitted in the private signal 114. The STA 108-1 may respond to the first trigger frame with an acknowledgement that is transmitted to the AP 102. When the AP 102 receives the acknowledgement, the AP 102 may transmit a second trigger frame, that is different from the first trigger frame, that indicates the STA 108-1 should use the new private MAC address 106-2. The AP 102 may transmit the second trigger frame as the AP 102 rotates to the new private MAC address 106-2. In one embodiment, the AP 102 transmits the second trigger frame to only STAs that sent an acknowledgement to the AP 102 within a configurable amount of time after the first trigger frame. The STA 108-1 may use the new private MAC address 106-2 to continue communicating with the AP 102. The AP 102 may continue accepting signals from STAs that received the first trigger frame, but did not transmit an acknowledgement, for a configurable amount of time after transmitting the second frame.

In one embodiment, the AP 102 transmits a vector of new MAC addresses to the STA 108-1. The AP 102 may rotate through the vector of new MAC addresses in a sequence. The AP 102 may transmit the vector of new MAC addresses to each STA associated with the AP 102. In one embodiment, the vector of new MAC addresses is transmitted in the private signal 114. The AP 102 may transmit to the STA 108-1 an algorithm for computing the new private MAC address 106-2 and a rotation timing indicating when the AP 102 will rotate to the new private MAC address. In one embodiment, the AP 102 transmits the vector of new MAC addresses, the algorithm, and the rotation timing in the same signal. The rotation timing may be in terms of epochs. The STA 108-1 may automatically determine the new private MAC address 106-2 using the vector of new MAC addresses, the algorithm for computing the new private MAC address, and the rotation timing without the AP 102 indicating the new private MAC address 106-2. After the AP 102 rotates the private MAC address 106-1 to the new private MAC address 106-2, the STA may determine and use the private MAC address 106-2 to send the data signal 116 to the AP 102. The AP 102 may transmit an update signal to the STA 108-1 that includes an epoch, which the STA 108-1 may use along with the algorithm, the vector of new MAC addresses, the algorithm, and the rotation timing to confirm the new private MAC address 106-2. In one embodiment, the AP 102 transmits the update signal a configurable amount of time after rotating to the new private MAC address 106-2.

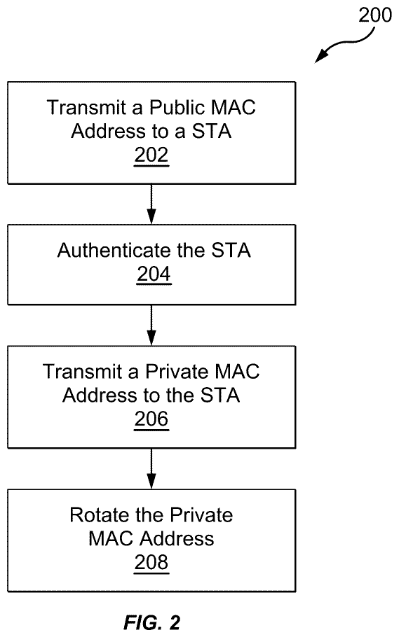

FIG. 2 depicts a flowchart of a method 200 performed by an AP (such as the AP 102 in FIG. 1) to rotate a private MAC address (such as the private MAC address 106-1 in FIG. 1) while maintaining association with a STA (such as the STA 108-1). The AP may broadcast a signal (such as the broadcast signal 110 in FIG. 1) for the STA to use for associating with the AP. The broadcast signal may include parameters of the AP that the STA may use for association. For example, at block 202, the AP may transmit a public MAC address (such as the public MAC address 104 in FIG. 1) to the STA. The STA may choose to associate with the AP using the parameters indicated in the broadcast signal.

In one embodiment, the STA responds to the broadcast signal, attempting to associate with the AP. At block 206, the STA and AP may continue to associate by going through the SAE process to authenticate the STA. The STA and AP may follow-up the SAE process with a 4-way handshake to generate a PTK and GTK for secure communication between the STA and the AP. After the 4-way handshake, at block 204, the AP associates with the STA. The AP may transmit the private MAC address to the STA in a private signal (such as the private signal 114 in FIG. 1). The AP may indicate in the private signal that the STA should communicate with the AP using the private MAC address.

The AP may determine that the private MAC address should be rotated. The AP may transmit an indication to the STA that the AP will rotate the private MAC address. At block 208, the AP rotates the private MAC address to a new private MAC address (such as the new private MAC address 106-2 in FIG. 1). The STA may remain associated with the AP through the public MAC address. The STA may continue communicating with the AP using the new private MAC address.

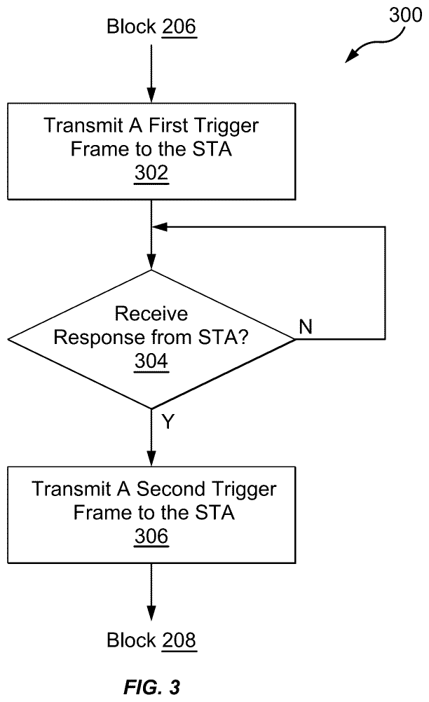

FIG. 3 depicts a flowchart of a method 300 performed by an AP (such as the AP 102 in FIG. 1) to transmit a trigger frame before rotating a private MAC address (such as the private MAC address 106-1 in FIG. 1) while maintaining association with a STA (such as the STA 108-1 in FIG. 1). The method 300 may occur after the AP transmits the private MAC address to the STA as indicated in block 206 in FIG. 2. The AP may use trigger frames for indicating to the STA that the AP will rotate to a new private MAC address (such as the new private MAC address 106-2 in FIG. 1). For example, at block 302, the AP transmits a first trigger frame to the STA indicating the AP will rotate the private MAC address. The first trigger frame may be transmitted to the STA in a private, encoded signal (such as the private signal 114 in FIG. 1). The first trigger frame may include the new private MAC address. After transmitting the first trigger frame, at block 304, the AP may wait to receive a response from the STA indicating that the STA received the first trigger. If the AP does not receive a response, the AP may continue to wait for the response before rotating to the new private MAC address. In one embodiment, the AP re-transmits the first trigger frame to the STA after waiting for a configurable amount of time since transmitting the first trigger frame. When the AP receives the response from the STA, at block 306, the AP transmits a second trigger frame to the STA indicating to start using the new private MAC address. After transmitting the second trigger frame, the AP may rotate the private MAC address to the new private MAC address as described in block 208 in FIG. 2.

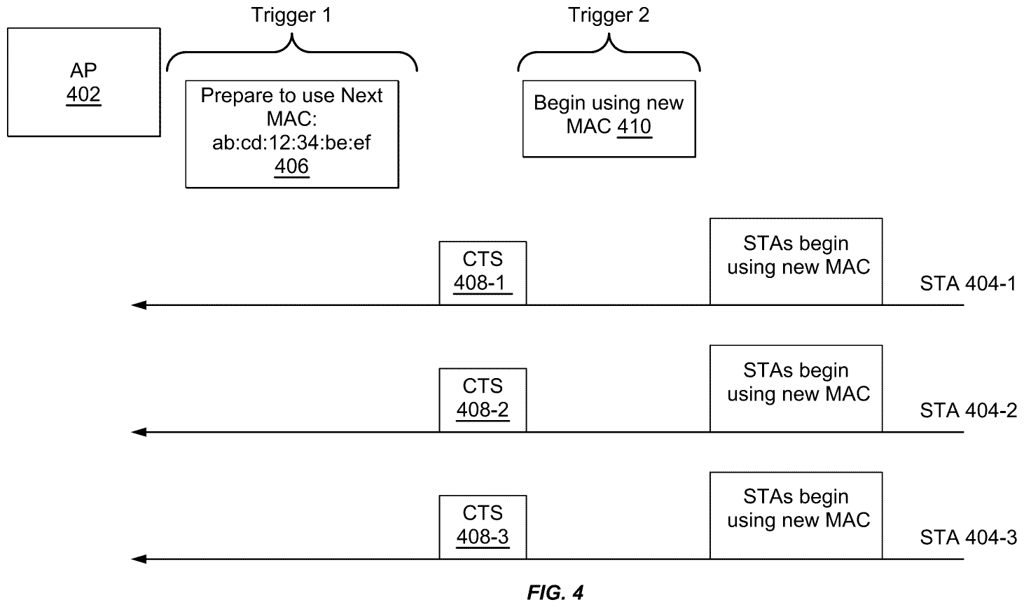

FIG. 4 depicts a block diagram of an AP 402 transmitting multiple trigger frames before rotating a MAC address to a new MAC address while maintaining association with multiple STAs 404-1 through 404-3. The AP 402 may be associated with each of the STAs 404-1 through 404-3. The AP 402 may transmit a first trigger frame 406 to the STAs 404-1 through 404-3 indicating that the AP 402 will rotate the MAC address to a new MAC address for the STAs 404-1 through 404-3 to use after the AP 402 rotates. The AP 402 may wait for a response from the STAs 404-1 through 404-3 before rotating the MAC address to the new MAC address. In one embodiment, the AP 402 may wait a configurable amount of time after transmitting the first trigger frame 406 before re-transmitting the first trigger frame 406. Each of the STAs 404-1 through 404-3 may transmit clear to send (CTS) signals 408-1 through 408-3 to the AP 402 indicating that the STAs 404-1 through 404-3 received the first trigger frame 406. In response to the CTS signals 408-1 through 408-3, the AP 402 may transmit a second trigger frame 410 to each of the STAs 404-1 through 404-3, indicating that the STAs 404-1 through 404-3 should begin using the new MAC address, and may rotate to the new MAC address. In one embodiment, the AP 402 waits for a configurable amount of time after receiving one CTS signal before transmitting the second trigger frame 410. In this embodiment, the AP 402 may transmit the second trigger frame 410 to STAs that responded to the first trigger frame 406 and not to STAs that did not respond to the first trigger frame 406. The AP 402 may accept signals from the STAs that did not respond to the first trigger frame 406 for a configurable amount of time after rotating to the new MAC address. The STAs 404-1 through 404-3 may begin using the new MAC address to communicate with the AP 402.

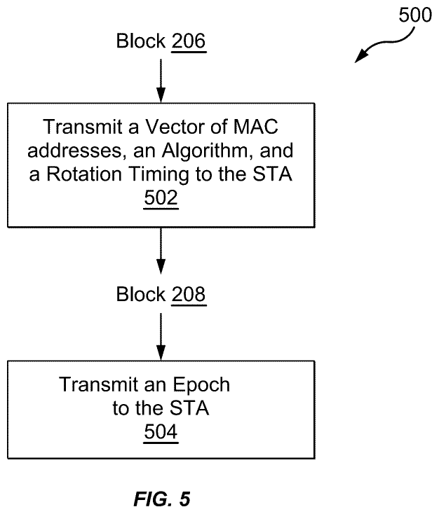

FIG. 5 depicts a flowchart of a method 500 performed by an AP (such as the AP 102 in FIG. 1) to transmit a vector of MAC addresses before rotating a private MAC address (such as the private MAC address 106-1 in FIG. 1) while maintaining association with a STA (such as the STA 108-1 in FIG. 1). The method 500 may occur after the AP transmits the private MAC address to the STA as indicated in block 206 in FIG. 2. The AP may transmit a signal to the STA indicating that the AP will rotate the private MAC address to a new private MAC address (such as the new private MAC address 106-2 in FIG. 1). For example, at block 502, the AP may transmit a signal indicating that the AP will rotate the private MAC address along with a vector of MAC addresses, an algorithm for computing the new private MAC address, and a rotation timing indicating when the AP will rotate to the new private MAC address. The rotation timing may be in terms of epochs. The STA may use the vector of new MAC addresses, the algorithm, and the rotation timing to automatically determine the new private MAC address. After transmitting the signal to the STA, the AP may rotate the private MAC address to the new private MAC address as described in block 208 in FIG. 2. The AP may continue to sequentially rotate the new private MAC address to a new address in the vector of MAC addresses.

After a configurable amount of time since rotating to the new private MAC address, at block 504, the AP transmits an epoch to the STA. The STA may use the epoch, the vector of MAC addresses, the algorithm, and the rotation timing to confirm the new private MAC address.

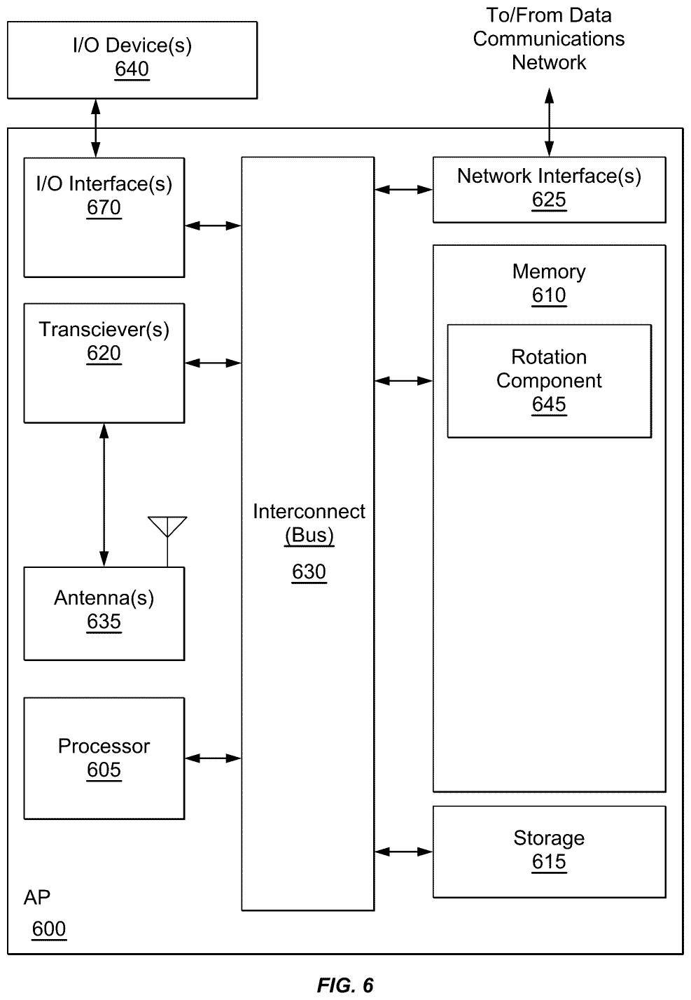

FIG. 6 depicts an example network device 600 configured to perform various aspects of the present disclosure, according to some aspects of the present disclosure. The network device 600 may be an AP, which corresponds to the AP 102 as depicted in FIG. 1.

As illustrated, the example network device 600 includes a processor 605, memory 610, storage 615, one or more transceivers 620, one or more I/O interfaces 680, and one or more network interfaces 625. In some embodiments, I/O devices 640 are connected via the I/O interface(s) 680. Further, via the network interface 625, the network device 600 can be communicatively coupled with one or more other devices and components (e.g., via a network, which may include the Internet, local network(s), and the like). Each of the components is communicatively coupled by one or more buses 630. In some embodiments, one or more antennas 635 may be coupled to the transceivers 620 for transmitting and receiving wireless signals.

The processor 605 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 605 processes information received through the transceiver 620, I/O interfaces 680, and the network interfaces 625. The processor 605 retrieves and executes programming instructions stored in memory 610, as well as stores and retrieves application data residing in storage 615.

The storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 615 may store a variety of data for the efficient functioning of the system.

The memory 610 may include random access memory (RAM) and read-only memory (ROM). The memory 610 may store processor-executable software code containing instructions that, when executed by the processor 605, enable the network device 600 to perform various functions described herein for wireless communication. In the illustrated example, the memory 610 includes a software component: rotation component 645.

In one embodiment, the rotation component 645 is configured to determine how the AP 102 rotates a private MAC address (such as the private MAC address in FIG. 1) and how the AP 102 transmits a new private MAC address to a STA (such as the STAs 108-1 and 108-2 in FIG. 1). In one embodiment, the rotation component 645 is configured to determine trigger frames to transmit to the STA according to the method 300 in FIG. 3. In one embodiment, the rotation component 645 is configured to determine a vector MAC address, an algorithm, and a rotation timing to transmit to the STA according to the method 500 in FIG. 5.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point (AP) comprising:
one or more memories; and
one or more processors communicatively coupled to the one or more memories, wherein the one or more processors are configured to, individually or collectively, perform an operation comprising:
transmitting a public media access control (MAC) address to a station (STA) for communicating with the AP as the STA associates with the AP;
responsive to the STA associating with the AP, transmitting a private MAC address to the STA, such that the STA communicates with the AP using the private MAC address instead of the public MAC address; and
rotating the private MAC address to a new private MAC address, wherein the STA remains associated with the AP while the private MAC address is rotated to the new private MAC address.

2. The AP of claim 1, wherein the private MAC address is transmitted in an encoded signal to the AP.

3. The AP of claim 1, wherein the operation further comprises:
prior to rotating the private MAC address, transmitting a first trigger frame to the STA indicating that the private MAC address will rotate to a new address, wherein the first trigger frame comprises the new private MAC address;
receiving a response from the STA acknowledging that the STA received the first trigger frame; and
responsive to receiving the response from the STA, transmitting a second trigger frame informing the STA to use the new private MAC address instead of the private MAC address.

4. The AP of claim 1, wherein the STA is one of a plurality of STAs associated with the AP and wherein the operation further comprises:
prior to rotating the private MAC address, transmitting a first trigger frame to each of the plurality of STAs indicating that the private MAC address will rotate to a new private MAC address, wherein the first trigger frame comprises the new private MAC address;
receiving responses from each STA in a subset of STAs of the plurality of STAs acknowledging that each STA in the subset of STAs received the first trigger frame; and
responsive to receiving the response from the subset of STAs, transmitting a second trigger frame informing the subset of STAs to use the new private MAC address instead of the private MAC address.

5. The AP of claim 4, wherein the operation further comprises:
after a configurable amount of time after transmitting the first trigger frame, denying frames from a second subset of STAs of the plurality of STAs that did not send a response acknowledging the first trigger frame.

6. The AP of claim 1, wherein the STA is one of a plurality of STAs associated with the AP and wherein the operation further comprises:
prior to rotating the private MAC address, transmitting a vector of MAC addresses; and
wherein rotating to the new private MAC address comprises sequentially rotating the private MAC address to a next one of the MAC addresses in the vector of MAC addresses.

7. The AP of claim 6, wherein transmitting the vector of MAC addresses further comprises:
transmitting an algorithm for computing the new private MAC address from the vector of MAC addresses and a rotation timing, wherein the STA can communicate with the AP through the new private MAC address determined from the algorithm and the rotation timing.

8. The AP of claim 7, wherein the operation further comprises:
after transmitting the algorithm, transmitting an epoch to the STA to determine the new private MAC address.

9. A method comprising:
transmitting, by an access point (AP) a public media access control (MAC) address to a station (STA) for communicating with the AP as the STA associates with the AP;
responsive to the STA associating with the AP, transmitting a private MAC address to the STA, such that the STA communicates with the AP using the private MAC address instead of the public MAC address; and
rotating the private MAC address to a new private MAC address, wherein the STA remains associated with the AP while the private MAC address is rotated to the new private MAC address.

10. The method of claim 9, wherein the private MAC address is transmitted in an encoded signal to the AP.

11. The method of claim 9, further comprises:
prior to rotating the private MAC address, transmitting a first trigger frame to the STA indicating that the private MAC address will rotate to a new private MAC address, wherein the first trigger frame comprises the new private MAC address;
receiving a response from the STA acknowledging that the STA received the first trigger frame; and
responsive to receiving the response from the STA, transmitting a second trigger frame informing the STA to use the new private MAC address instead of the private MAC address.

12. The method of claim 9, wherein the STA is one of a plurality of STAs associated with the AP and further comprises:
prior to rotating the private MAC address, transmitting a first trigger frame to each of the plurality of STAs indicating that the private MAC address will rotate to a new private MAC address, wherein the first trigger frame comprises the new private MAC address;
receiving responses from each STA in a subset of STAs of the plurality of STAs acknowledging that each STA in the subset of STAs received the first trigger frame; and
responsive to receiving the response from the subset of STAs, transmitting a second trigger frame informing the subset of STAs to use the new private MAC address instead of the private MAC address.

13. The method of claim 12, further comprises:
after a configurable amount of time after transmitting the first trigger frame, denying frames from a second subset of STAs of the plurality of STAs that did not send a response acknowledging the first trigger frame.

14. The method of claim 9, wherein the STA is one of a plurality of STAs associated with the AP and further comprises:
prior to rotating the private MAC address, transmitting a vector of MAC addresses; and
wherein rotating to the new private MAC address comprises sequentially rotating the private MAC address to a next one of the MAC addresses in the vector of MAC addresses.

15. The method of claim 14, wherein transmitting the vector of MAC addresses further comprises:
transmitting an algorithm for computing the new private MAC address from the vector of MAC addresses and a rotation timing, wherein the STA can communicate with the AP through the new private MAC address determined from the algorithm and the rotation timing.

16. The method of claim 15, further comprises:
after transmitting the algorithm, transmitting an epoch to the STA to determine the new private MAC address.

17. A non-transitory computer-readable medium containing computer program code that, when executed by operation of one or more computer processors, performs operations comprising:
transmitting a public media access control (MAC) address to a station (STA) for communicating with an access point (AP) as the STA associates with the AP;
responsive to the STA associating with the AP, transmitting a private MAC address to the STA, such that the STA communicates with the AP using the private MAC address instead of the public MAC address; and
rotating the private MAC address to a new private MAC address, wherein the STA remains associated with the AP while the private MAC address is rotated to the new private MAC address.

18. The non-transitory computer-readable medium of claim 17, wherein the private MAC address is transmitted in an encoded signal to the AP.

19. The non-transitory computer-readable medium of claim 17, wherein the operation further comprises:
prior to rotating the private MAC address, transmitting a first trigger frame to the STA indicating that the private MAC address will rotate to a new address, wherein the first trigger frame comprises the new private MAC address;
receiving a response from the STA acknowledging that the STA received the first trigger frame; and
responsive to receiving the response from the STA, transmitting a second trigger frame informing the STA to use the new private MAC address instead of the private MAC address.

20. The non-transitory computer-readable medium of claim 17, wherein the STA is one of a plurality of STAs associated with the AP and wherein the operation further comprises:
prior to rotating the private MAC address, transmitting a first trigger frame to each of the plurality of STAs indicating that the private MAC address will rotate to a new address, wherein the first trigger frame comprises the new private MAC address;
receiving responses from each STA in a subset of STAs of the plurality of STAs acknowledging that each STA in the subset of STAs received the first trigger frame; and
responsive to receiving the response from the subset of STAs, transmitting a second trigger frame informing the subset of STAs to use the new private MAC address instead of the private MAC address.
